(19) United States
(12) Patent Application Publication
(10) Pub. No.: US 2024/0317332 A1
(43) Pub. Date: Sep. 26, 2024

(54) PLUG-IN COUPLING SYSTEM AND FIFTH WHEEL ASSEMBLY WITH PLUG-IN COUPLING SYSTEM

(71) Applicant: SAF-HOLLAND GmbH, Bessenbach (DE)

(72) Inventor: Mario Sebastian Köster, Bodman-Ludwigshafen (DE)

(21) Appl. No.: 18/563,114

(22) PCT Filed: May 31, 2022
(86) PCT No.: PCT/EP2022/064716

§ 371 Date: Nov. 21, 2023

(30) Foreign Application Priority Data
Jun. 2, 2021 (DE) 10 2021 114 310.1

(51) Int. Cl. B62D 53/12; B62D 53/08; B62D 53/10

(52) U.S. Cl. CPC B62D 53/125; B62D 53/0842; B62D 53/10

(57) ABSTRACT

A plug-in coupling system for a commercial vehicle includes a primary coupling device having a plug console with transmission contacts that point in a plug-in direction, a secondary coupling device having a connection console configured such that the plug console and the connection console are connected to one another so that information and/or energy can be transmitted between the plug console and the connection console, or disconnected from one another where no information and/or energy can be transmitted between the plug console and the connection console, and a locking device is configured to move between a locking position to prevent a transfer from the coupling position to the disconnecting position and a release position to permit a transfer from the coupling position to the disconnecting position.

### BACKGROUND

The invention relates to a plug-in coupling system, in particular for a fifth wheel coupling, and to a fifth wheel coupling comprising a plug-in coupling system.

Plug-in couplings are already known from the prior art. These are used to transfer energy or information between a towing vehicle and a towed vehicle, wherein the energy transfer connection or information transfer connection is or can be established automatically after or during a coupling process. However, a problem with devices known from the prior art is that the connection of the plug-in coupling system can easily be lost, especially unintentionally.

It is therefore the object of the present invention to provide a device which can ensure an automatic energy conducting or information conducting connection between a towing vehicle and a trailer and prevent an unintentional loss of the connection.

### SUMMARY OF THE INVENTION

According to the invention, a plug-in coupling system is provided, in particular for a fifth wheel assembly of a commercial vehicle. Advantageously, the plug-in coupling system comprises a primary coupling device and a secondary coupling device, wherein the primary coupling device has a plug console with transmission contacts, wherein the transmission contacts point in particular in a plug-in direction, wherein the secondary coupling device has a connection console, wherein the plug-in coupling system has a locking device, wherein the plug-in coupling system is designed in such a way that the plug console and the connection console are connected to one another in a coupling position, so that information and/or energy can be transmitted directly or indirectly between the plug console and the connection console, wherein the plug-in coupling system is designed in such a way that the plug console and the connection console can be transferred to a disconnecting position, wherein, in the disconnecting position, no information and/or energy can be transmitted directly or indirectly between the plug console and the connection console, wherein the locking device is designed in such a way that, in a locking position, it prevents transfer from the coupling position to the disconnecting position in a form-fitting manner and, in a release position, permits transfer from the coupling position to the disconnecting position. The plug-in coupling system according to the invention is intended to be used in a commercial vehicle fifth wheel assembly. The plug-in coupling system has the primary task of transferring information and/or energy between a towing vehicle, on which a fifth wheel plate may be arranged, and a towed vehicle, on which a king pin may be arranged. In particular, this plug-in coupling system is designed in such a way that it can establish the energy- or information-conducting connection between the towing vehicle and the towed vehicle without any user intervention. In other words, the plug-in coupling system may be an automatic plug-in coupling system. In an exemplary embodiment, the plug-in coupling system may be designed to be drive-free, such that the information and/or energy connection between the plug console and the connection console may be established solely by the approach motion during the coupling process between the towed vehicle and the towing vehicle. Alternatively or additionally preferably, the plug-in coupling system can also be designed in such a way that the energy or information connection is established only after a coupling process, for example by a drive. The plug-in coupling system, in particular the primary coupling device and/or the secondary coupling device, may comprise a drive, in particular a connection drive. In particular, the plug-in coupling system comprises a primary coupling device and a secondary coupling device. The primary coupling device is designed and intended to be arranged on the towing vehicle or the towed vehicle. The secondary coupling device, on the other hand, is designed and intended to be arranged on the opposite commercial vehicle coupling partner, hence on the towed or the towing vehicle. In other words, therefore, the primary coupling device is arranged on the one vehicle and the secondary coupling device is arranged on the other vehicle. The primary coupling device has a plug console which has transmission contacts. This plug console is designed and intended to be engageable with the connection console of the secondary coupling device in such a way that information and/or power can be transmitted between the plug console and the connection console when the plug-in coupling system is in the coupling position. For this purpose, the plug console has, in particular, transmission contacts, which can be, for example, electrical line contacts, hydraulic line connections and/or pneumatic line connections. These transmission contacts of the plug console point in particular in the plug-in direction. This plug-in direction is thereby in particular the direction in which the primary coupling device must be displaced in relation to the secondary coupling device in order to establish an energy-conducting and/or information-conducting contact between the plug console and the connection console. It is particularly preferred if the plug-in direction is arranged or oriented parallel to a retraction direction of a fifth wheel coupling plate. In particular, in the coupling position, the plug-in direction is parallel to that direction in which a king pin must be displaced in relation to a fifth wheel coupling plate in order to be securely anchored in the fifth wheel coupling plate or to be able to be coupled. The plug-in direction can alternatively or additionally preferably be oriented parallel to the grade extension direction of the commercial vehicle on which the plug-in coupling system is arranged. In the coupling position of the plug-in coupling system, a transmission of information and/or energy between the plug console and the connection console is possible directly and/or indirectly. However, if the plug-in coupling system is in a disconnecting position, in particular no information and/or energy transfer is possible between the plug console and the connection console. Advantageously, a transfer from the coupling position to the disconnecting position is necessary by a displacement in plug-in direction between the plug console and the connection console, in particular by the drive. In other words, this can mean that a transfer from the coupling position to the disconnecting position requires a relative movement of the plug console to the connection console in the plug-in direction. In order to prevent the plug-in coupling system from unintentionally escaping from the coupling position, in particular into the disconnecting position, the plug-in coupling system has a locking device. This locking device is designed in such a way that it can be brought into a locking position and into a release position. In other words, the locking device has two states in particular, namely a locking position and a release position. In the blocking position, the blocking device prevents escape from the coupling position into the disconnecting position, in particular in a form-fitting manner. In the release position, however, the locking device does not prevent a transfer from the coupling position to the disconnecting position. The locking device can be a hook-and-eye system, for example. Alternatively, or additionally, the locking device can also be/feature a locking pin system and/or comprise a locking pin which, in the locking position, prevents a transfer from the coupling position to the disconnecting position in a form-fitting manner. The use of a form-fitting prevention system ensures in a particularly simple and effective manner that the locking device can reliably prevent an unintentional exit from the coupling position into the disconnecting position.

Expediently, the locking device has an actuator, wherein the actuator can transfer the locking device into the locking position or into the release position. The actuator is therefore a means which can actively influence the state of the locking device. By using an actuator, the position or state of the locking device can be influenced in a targeted manner. Expediently, the actuator has an energy connection through which, in particular, actuation of the actuator can be effected in a targeted manner. The actuator is designed to be bidirectional in particular. Bidirectional means that the actuator can move the locking device into the locking position and into the release position and vice versa.

In a particularly preferred embodiment, the locking device has a biasing means, wherein the biasing means forces the locking device into the locking position or the release position. For example, a spring or other force storage means attempts to guide or hold the locking device, in particular constantly, into the locking position or the release position. This can ensure that the locking device assumes a defined state even in the event of a power failure, so that the safety of the system can be further increased as a result.

In an advantageous embodiment, the actuator is a compressed air cylinder, a magnetic drive, a linear motor or a hydraulic cylinder. By designing the actuator as a compressed air cylinder, the compressed air system available in a commercial vehicle can be used in a particularly simple manner to actuate the actuator, so that an actuator that is particularly easy to actuate and install can be achieved. If the actuator is designed as a magnetic and/or electric drive, the on-board power supply of the commercial vehicle can be used in a particularly simple manner. If the actuator is designed as a linear motor, this results in a particularly compact actuator so that valuable installation space can be saved. If the actuator is designed as a hydraulic cylinder, this can result in a particularly lightweight but at the same time compact actuator, so that valuable installation space can also be saved.

Expediently, the locking device has a locking means, which is in particular a locking pin, and/or a locking structure, wherein the locking means and the locking structure are designed in particular to be complementary to one another. By “designed complementary to one another” is to be understood in particular that the locking means can be inserted into the locking structure, advantageously without an interference fit being formed between the locking means and the locking structure. Alternatively, or additionally preferably, complementary can also be understood to mean that the locking means and the locking structure have identically or similarly formed basic structural cross sections, for example circular or elliptical cross sections, and can be guided into one another. The locking means is designed in particular as a male contact partner of the locking device and is advantageously displaceable by the actuator. The locking structure, on the other hand, is advantageously designed as a counterpart to the locking means, in particular as a female structure, and interacts positively with the locking means in the locking position in such a way that a transfer from the coupling position to the separating position is prevented in a form-fitting manner. However, the locking structure can also be designed, for example, as a ball or a stop element behind which the locking means can engage in a form-fitting manner. The locking means and/or the locking structure can, for example, be or comprise a mechanical intermediate element, in particular a retaining ring, a piston rod extension or a ring, advantageously with re-hooks.

It is expedient that the locking device can be designed in such a way that the locking action of the locking device is not achieved directly by the actuator. This is particularly advantageous, for example, because it allows the locking position to be maintained even if the actuator fails. In other words, the actuator can only indirectly move the locking device to the locking position and/or to the separating position. This type of locking device may be referred to as an indirectly acting locking device in the sense of the invention. For example, this can be done by a ring which is displaceable by the actuator and which surrounds an elastic locking structure in the locking position so as to prevent or limit elastic deformation of the locking structure in such a way that an element received in the locking structure cannot leave the locking structure. In the separation position, however, the ring is displaced in such a way that it permits elastic deformation of the locking structure so that the received element can be guided out of or into the locking structure.

It is expedient that the locking means is mounted and/or held in such a way that it can be displaced by a translatory movement from the locking position into the release position, in particular along a displacement direction, in particular by the actuator. The locking means is therefore in particular mounted or held, in particular on or by the actuator or the base body of the actuator, in such a way that the locking device is or can be transferred from the locking position to the release position and/or vice versa by a, in particular exclusive, translatory movement of the locking means. This translatory movement of the locking means takes place along a displacement direction of the locking means. The exclusively translatory movement of the locking means makes it possible to achieve a particularly compact locking device that is simple to construct, so that the locking device is particularly cost-effective and saves installation space.

In an advantageous embodiment, the displacement direction is transverse, in particular perpendicular, to the plug-in direction. By a transverse it is to be understood that the smaller angle between the displacement direction and the plug-in direction is at least 30°, preferably at least 60° and particularly preferably at least 75° and/or does not exceed 90°. By forming the displacement direction and the plug-in direction transverse to each other, a particularly compact arrangement in the plug-in direction can be achieved. Should the angle between the displacement direction and the plug-in direction be at least 30°, a locking device which is particularly easy to manufacture can be achieved by this. Should the angle be at least 60°, a particularly compact locking device can be achieved both in the displacement direction and in the plug-in direction. Should the angle between the displacement direction and the plug-in direction be at least 75°, a particularly secure form-fitting device can be achieved here. However, it is particularly preferred if the displacement direction and the plug-in direction are perpendicular to each other, because this allows a particularly compact locking device that is at the same time very secure and easy to manufacture and assemble to be achieved.

Advantageously, the locking structure is a groove or a recess for receiving the locking means, or the locking structure can be designed as a projection. By designing the locking structure as a groove or as a recess, a particularly space-saving locking device can be achieved, which is also particularly easy to manufacture. A recess in this context means a female design which can be produced, for example, as a bore, by stamping or by a milling process. If the blocking structure is designed as a projection, a particularly mechanically loadable device can be achieved in this way, so that by designing the blocking means as a projection, mechanical weakening of the element which has the blocking structure can be avoided or at least reduced.

Advantageously, the primary coupling device and the secondary coupling device have guide structures or a guide structure, in particular in the form of a guide mandrel or a guide sleeve. The guide structures or the guide structure thereby serve or serves to guide the primary coupling device in relation to the secondary coupling device. In other words, the guide structures of the primary coupling device and/or the secondary coupling device can ensure that the primary coupling device and the secondary coupling device can be guided safely from the disconnecting position to the coupled position. In particular, the guide structures are thereby designed in such a way that they can prevent an undesired displacement, in particular perpendicular to the plug-in direction, in particular in a form-fitting manner. The guide structures can be designed, for example, as guide mandrels or as complementary guide receiving structures, in particular as guide sleeves. These guide receiving structures are, in particular, female embodiments of guide elements which can serve, for example, and/or are designed in such a way that guide mandrels can be securely received. Expediently, the guide elements extend in the plug-in direction. By using guide structures, a particularly safe transfer to the coupling position of the plug-in coupling system can be achieved.

In a particularly preferred embodiment, at least one locking structure and/or a plurality of locking structures are arranged or formed on and/or in the guide structure. By using the guide structure and/or some of the guide structures in such a way that they form part of the locking device, a particularly simple and low-component design of a plug-in coupling system with a locking device can be achieved. In addition, a particularly simple maintainability and/or replaceability of the locking device can be achieved by this, because the accessibility of the locking structure is increased or simplified by this.

Advantageously, the primary coupling device and/or the secondary coupling device has a receiving structure, in particular for receiving or guiding the guide structure, wherein the receiving structure in the release position allows a counterpart, in particular a guide structure, to be inserted by elastic deformation, wherein the receiving structure in the locking position prevents the counterpart from being inserted, in particular in a form-fitting manner. The receiving structure can, for example, be a guide sleeve. The receiving structure can have, in particular inwardly projecting re-hooks or structures which form a locking contact with the counterpart in the locking position. The counterpart is in particular part of the secondary coupling device if the receiving structure is part of the primary coupling device or vice versa. The counterpart can in particular be a guide mandrel as described previously and below.

Advantageously, the or one receiving structure has slots, in particular in the plug-in direction. This can increase the elastic deformability of the receiving structure, in particular in order to be able to accommodate the largest possible counterparts. Furthermore, this can also reduce the amount of energy required for coupling, resulting in an energetically favourable device.

In a preferred embodiment, the receiving structure in the locked position is prevented by a surrounding and/or displaceable ring from permitting insertion or removal of a counterpart by elastic deformation, in particular of the receiving structure. For example, the ring can therefore surround the receiving structure in such a way that the ring prevents or hinders a deformation of the receiving structure in a form-fitting manner. The ring can be displaced, for example, by an or the actuator. An indirectly acting locking device can therefore be achieved by this. The ring is expediently displaceable in the plug-in direction or parallel to the plug-in direction, advantageously by the or an actuator, in particular in order to achieve a small size.

Expediently, a secondary locking device is provided, wherein the secondary locking device is designed or constructed in such a way that in its locking position it prevents a transfer from the coupling position to the separating position, in particular by form- or force-fitting, and in its release position it permits a transfer from the coupling position to the separating position. In other words, there may be a second locking device which can achieve locking, in particular independently of the (first) locking device. This can further increase the safety of the system. In this context, the secondary locking device may have any features, advantages, embodiments or designs as the locking devices described before or below.

Preferably, the locking device and the secondary locking device are based on different locking mechanisms. In other words, the energy source, in particular of the actuators, of the locking device and the secondary locking device may be different. For example, one actuator may be a pneumatic actuator and the other actuator may be a hydraulic actuator. Also, the locking device may have a direct locking action and the secondary locking device may have an indirect locking action or vice versa. A direct locking action is present in particular when the actuator displaces a locking means or a locking structure, which then locks in a form-fitting manner itself in particular. An indirect locking effect, on the other hand, is present in particular when the locking means only indirectly brings the locking means or the locking structure into the locking position, and therefore does not directly lock itself. Alternatively, or additionally preferably, “different locking mechanisms” can also be understood to mean that the locking action deployment is different. For example, the locking device can operate in a form-fitting manner and the secondary locking device in a non-form-fitting manner, in particular in a force-fitting manner and/or by means of a permanent force, advantageously in the plug-in direction. This permanent force can be achieved, for example, by a permanently pressurized compressed air cylinder when this is in the locked position.

Expediently, the primary coupling device and/or the secondary coupling device has a drive or a plurality of drives, wherein the drive or drives is/are designed in such a way as to transfer the primary coupling device and/or the secondary coupling device, in particular by a translatory movement in the plug-in direction, from the coupling position to the disconnecting position and/or from the disconnecting position to the coupling position. For example, the plug-in coupling system can therefore be designed in such a way that a transfer from the coupling position to the disconnecting position or from the disconnecting position to the coupling position is not effected by the approach of the vehicles to be coupled but by a separate drive. This has the particular advantage that the mechanical loads on the primary coupling device and the secondary coupling device can be reduced during a coupling process-between the towing vehicle and the towed vehicle-so that a particularly weight-saving primary coupling device or secondary coupling device can be achieved. Thus, a drive in the plug-in coupling system can effectively increase the available payload weight of the commercial vehicle.

For example, the actuator or one of the actuators may be a linear motor, a hydraulic motor, a hydraulic piston, and/or a pneumatic piston.

In an advantageous embodiment, the locking structure is arranged or formed on or in the drive, in particular in or on a piston rod of the drive. In this way, a particularly compact and space-saving locking device can be achieved, which can also be particularly effective in preventing unintentional separation or transfer from the coupling position to the separation position. For example, the locking structure can therefore be designed as a groove or a recess in or on the piston rod of a drive, which can be a double-acting cylinder, for example. This can reduce the mechanically loaded components in the event of an unintentional attempt to transfer from the clutch position to the disconnect position, so that material and weight can be saved as a result.

Another aspect of the invention relates to a fifth wheel coupling comprising a plug-in coupling system as described above or below. In particular, a fifth wheel coupling comprises a fifth wheel coupling plate and a king pin, wherein the primary coupling device may be arranged, for example, on the fifth wheel coupling plate and/or wherein the secondary coupling device may be arranged, in particular, in close proximity to the king pin. In this context, being arranged in close proximity can be understood to mean that the two components are at a maximum distance of 2 m, preferably 1 m, from one another when the system is in an assembled state, in particular in the coupling position.

Another aspect of the invention may relate to a commercial vehicle arrangement comprising a fifth wheel coupling and/or a fifth wheel coupling system as described above or below. In particular, a commercial vehicle arrangement comprises a towing vehicle and a towed vehicle. The commercial vehicle arrangement may therefore be formed by, for example, a towing vehicle and a semi-trailer.

### BRIEF DESCRIPTION OF THE DRAWINGS

Further advantages and features of the present invention will be apparent from the following description with reference to the figures. Individual features of the embodiment shown can thereby also be used on other embodiments, unless this has been expressly excluded. Showing:

FIG. 1 is a section through a plug-in coupling system;

FIG. 2 is a detailed view of the plug-in coupling system shown in FIG. 1;

FIG. 3 is an external view of a plug-in coupling system;

FIG. 4 is a side view of a plug-in coupling system;

FIG. 5 is a detailed view of the plug-in coupling system shown in FIG. 4;

FIG. 6 is a fifth wheel coupling comprising a plug-in coupling system; and

FIG. 7 shows an indirectly acting locking device.

### DETAILED DESCRIPTION

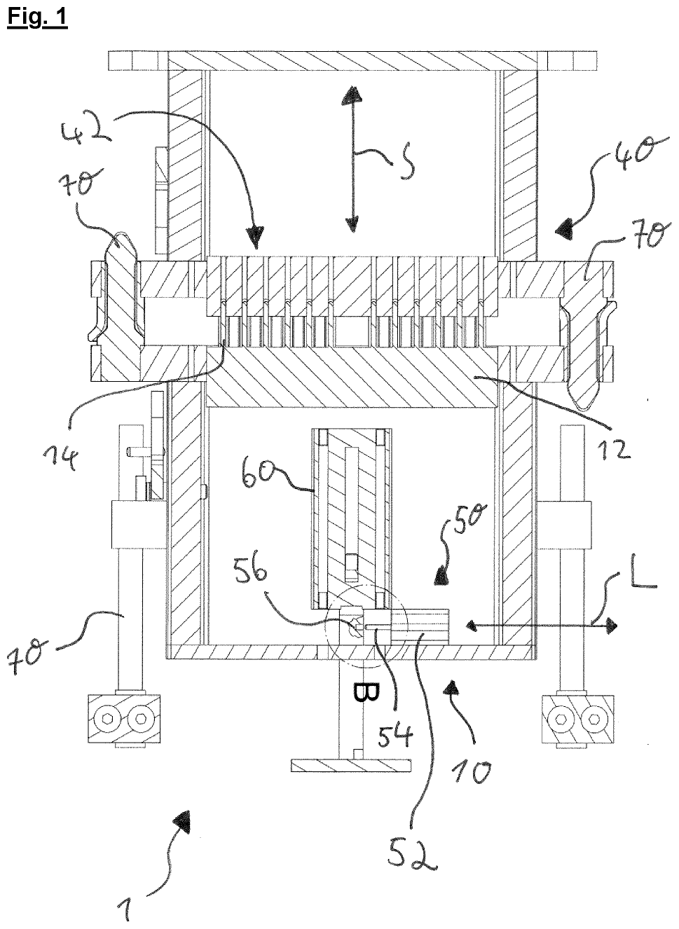

FIG. 1 shows a section through a plug-in coupling system 1. The sectional plane is defined by the displacement direction L and the plug-in direction S. The primary coupling device 10 and the secondary coupling device 40 are shown. The plug-in coupling system 1 has a primary coupling device 10 and a secondary coupling device 40. The primary coupling device 10 and the secondary coupling device 40 can be displaced relative to each other in the plug-in direction S, wherein in FIG. 1 the plug-in coupling system 1 is in the coupling position. The disconnecting position of the plug-in coupling system 1 is thereby spaced apart in the plug-in direction S from the coupling position shown in FIG. 1. The primary coupling device 10 has a plug console 12 which has transmission contacts 14 which extend in the plug-in direction S. Laterally spaced in displacement direction L from the transmission contacts 14 are guide structures 70, which can be designed both as guide mandrels and as guide sleeves, as exemplified in FIG. 1. Both the primary coupling device 10 and the secondary coupling device 40 each have a guide structure 70, which is designed as a guide mandrel, and a guide structure 70, which is designed as a guide sleeve receiving a guide mandrel. The primary coupling device 10 has a drive 60, which is designed as a double-acting cylinder and can displace the primary coupling device 10 in the plug-in direction S relative to the secondary coupling device 40, in order to transfer the plug-in coupling system 1 into the coupling position or into the disconnecting position. To prevent lateral displacement of the primary coupling device 10, the primary coupling device 10 has lateral guide structures 70 in the form of linear guides. In order to prevent an unintentional transfer from the coupling position to the disconnecting position in a form-locking manner, the plug-in coupling system 1 has a locking device 50. This locking device 50 has an actuator 52, a locking means 54 and a locking structure 56. The actuator 52 is thereby capable of displacing the locking means 54, which in the variant shown is a locking pin, in the displacement direction L in order to transfer the locking device 50 from the release position shown to the locking position. For this purpose, the locking means 54 performs a purely translatory movement in the displacement direction L. The locking structure 56 is designed as a locking structure 56 which is complementary to the locking means 54, in the illustrated embodiment as a bore.

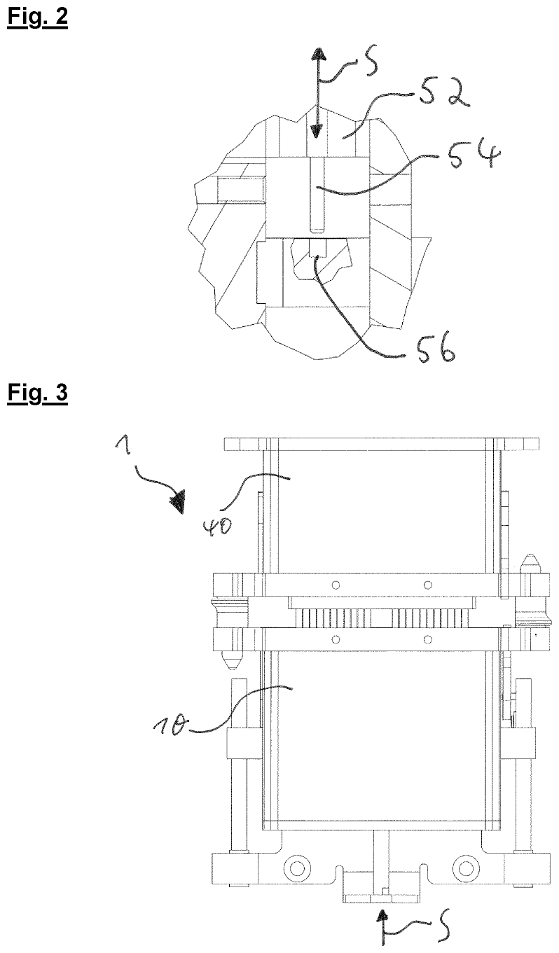

In FIG. 2, the area marked B in FIG. 1 is shown as a detailed view, wherein the design of the locking means 54 as a locking pin and the design of the locking structure 56 as a bore can be taken from FIG. 2.

FIG. 3 shows a top view of a plug-in coupling system 1 which can in particular match the plug-in coupling system 1 shown in FIG. 1. In FIG. 3, the plug-in coupling system 1 is also shown in the coupling position.

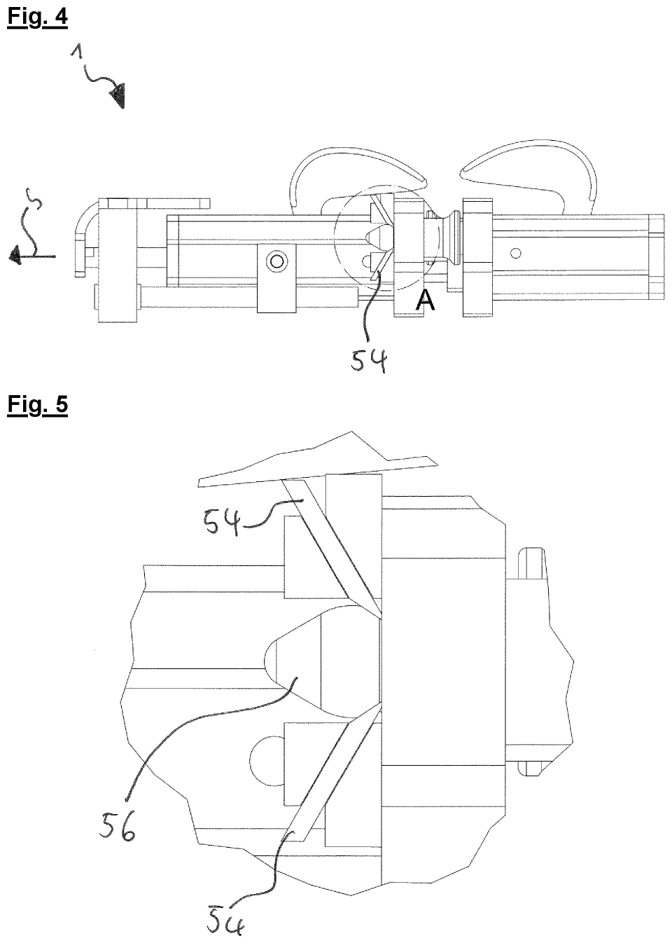

FIG. 4 shows a side view of a plug-in coupling system 1. In the embodiment shown, the locking means 54 are designed as sliders which can be brought into undercutting engagement with a distal end of a guide mandrel in order to prevent displacement of the primary coupling device 10 in relation to the secondary coupling device 40 in the plug-in direction S in a form-fitting manner.

FIG. 5 shows a detailed view of the area designated A in FIG. 4. As can be seen from FIG. 5, the locking means 54 are designed as translationally movable locking means 54, which can be brought into engagement with a locking structure 56 in a form-fitting manner. The locking structure 56 forms a distal end in the plug-in direction S of a guide structure 70. In other words, in the embodiment shown in FIG. 5, the locking structure 56 is formed as a protruding element and thus as a male element.

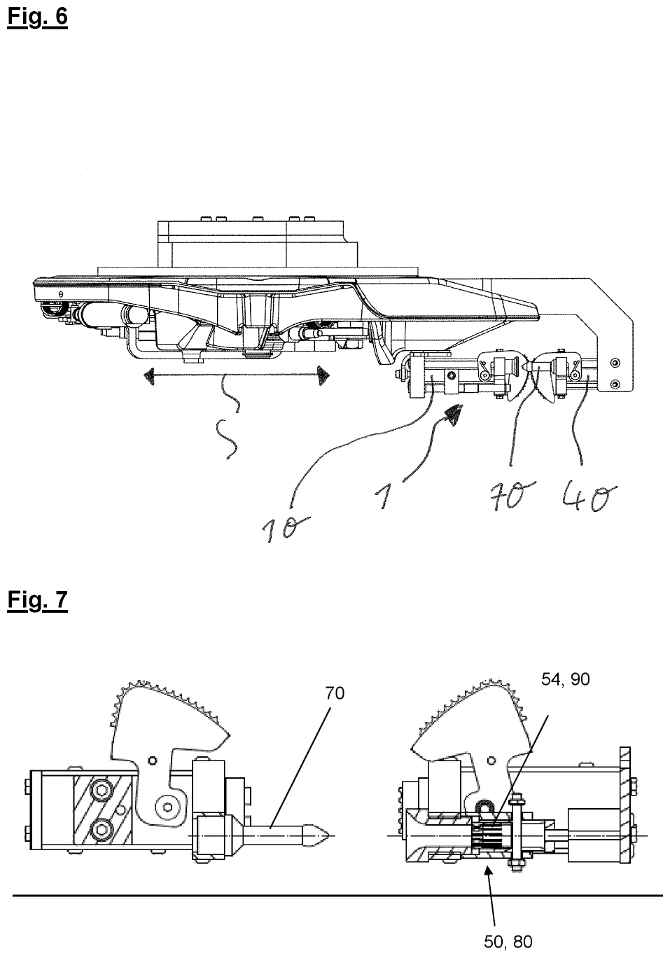

FIG. 6 shows a fifth wheel coupling comprising a plug-in coupling system 1. In FIG. 6, the plug-in coupling system 1 is in the disconnecting position so that no information and/or energy can be exchanged between the secondary coupling device 40 and the primary coupling device 10.

FIG. 7 shows an indirect-acting locking device 50, which can also be a secondary locking device 80. In other words, the device shown can therefore also be an additional locking device 50. The locking action of the secondary locking device 80/locking device 50 is indirect in this case, because the actual positive locking means 54 is formed by the receiving structure 90 in the form of a guide sleeve, which can be easily elastically deformed by the slots running in the plug-in direction S. A ring can be pushed around the receiving structure 90 by an actuator, which surrounds the receiving structure 90 in order to prevent deformation in the locking position in such a way that the guide structure 70 received in the receiving structure 90 is secured against escape in a form-fitting manner.

### LIST OF REFERENCE SIGNS

1—Plug-in coupling system
10—Primary coupling device
12—Plug console
14—Transmission contacts
40—Secondary coupling device
42—Connection console
50—Locking device
52—Actuator
54—Blocking agent
56—Locking structure
60—Drive
70—Guid structure
80—Secondary locking device
90—Receiving structure
L—Displacement direction
S—Plug-in direction

1.-15. (canceled)

16. A plug-in coupling system for a fifth wheel assembly, comprising:
a primary coupling device, a secondary coupling device, and a locking device;
wherein the primary coupling device comprises a plug console with transmission contacts;
wherein the transmission contacts point in a plug-in direction;
wherein the secondary coupling device comprises a connection console;
wherein the plug-in coupling system is configured such that the plug console and the connection console are connected to each other in a coupling position such that information and/or energy can be transmitted directly or indirectly between the plug console and the connection console;
wherein the plug-in coupling system is configured such that the plug console and the connection console is configured to be transferred into a disconnecting position, wherein in the disconnecting position no information and/or energy can be transmitted directly or indirectly between the plug console and the connection console;
wherein the locking device is configured such that in a locking position the locking device prevents a transfer from the coupling position to the disconnecting position in a form-fitting manner, and in a release position the locking device allows a transfer from the clutch position to the disconnect position; and
wherein the plug-in direction is oriented parallel to a retraction direction of a fifth-wheel coupling plate.

17. The plug-in coupling system according to claim 16, wherein the locking device comprises an actuator configured to transfer the locking device into the locking position or into the release position.

18. The plug-in coupling system according to claim 16, wherein the actuator includes a pneumatic cylinder, a magnetic drive, a linear motor, or a hydraulic cylinder.

19. The plug-in coupling system according to claim 16, wherein the locking device comprises a locking member including a locking pin and/or a locking structure, and wherein the locking member and the locking structure are formed complementary to each other.

20. The plug-in coupling system according to claim 16, wherein the locking arrangement is mounted such that the locking member is configured to be displaced by a translatory movement from the locking position into the release position along a displacement direction by the actuator.

21. The plug-in coupling system according to claim 16, wherein the displacement direction is transverse to the plug-in direction.

22. The plug-in coupling system according to claim 16, wherein the locking structure includes a groove or a recess for receiving the locking member or a protrusion.

23. The plug-in coupling system according to claim 16, wherein at least one of the primary coupling device and the secondary coupling device comprises a guide structure that includes a guide mandrel.

24. The plug-in coupling system according to claim 23, wherein at least one of the primary coupling device and the secondary coupling device comprises a receiving structure for receiving or guiding the guide structure, wherein the receiving structure in the release position allows an insertion of the guide structure by elastic deformation, and wherein the receiving structure in the locking position prevents the counterpart from being executed in a form-fitting manner.

25. The plug-in coupling system according to claim 24, wherein the receiving structure has slots extending in the plug-in direction.

26. The plug-in coupling system according to claim 24, wherein the receiving structure in the locked position is prevented by a surrounding and/or displaceable ring to allow an insertion or removal of the counterpart via an elastic deformation.

27. The plug-in coupling system according to claim 16, further comprising:
a secondary locking device, configured such, in its locking position, the secondary locking device prevents a transfer from the coupling position to the disconnecting position in a form- or force-fitting manner, and in a release position a transfer from the coupling position to the disconnecting position is permitted.

28. The plug-in coupling system according to claim 27, wherein the locking device and the secondary locking device and locking mechanisms are different from one another.

29. The plug-in coupling system according to claim 16, wherein at least one of the primary coupling device and the secondary coupling device comprise a drive configured to transfer the primary coupling device and/or the secondary coupling device by a translatory movement in the plug-in direction from the coupling position to the disconnecting position and/or from the disconnecting position to the coupling position.

30. A fifth wheel assembly comprising the plug-in coupling system according to claim 16 and the fifth-wheel coupling plate.

31. A fifth wheel coupling, comprising:
a fifth wheel coupling plate; and
a plug-in coupling system, comprising:
a primary coupling device including a plug console with transmission contacts that point in a plug-in direction that is substantially parallel to a retraction direction of the fifth wheel coupling plate, and a secondary coupling device including a connection console, wherein the the plug console and the connection console are movable between a connected position where information and/or energy can be transmitted directly or indirectly between the plug console and the connection console, and a disconnected position no information and/or energy can be transmitted directly or indirectly between the plug console and the connection console; and
a locking device movable between a locking position where the locking device prevents a transfer from the coupling position to the disconnecting position in a form-fitting manner, and in a release position where the locking device allows a transfer from the clutch position to the disconnect position, wherein the locking device includes an actuator configured to transfer the locking device between the locking position and the release position.

32. The fifth wheel coupling according to claim 31, wherein the actuator includes a pneumatic cylinder, a magnetic drive, a linear motor, or a hydraulic cylinder.

33. The fifth wheel coupling according to claim 31, wherein the locking device includes a locking member and a locking structure, wherein the locking member and the locking structure are formed complementary to each other.

34. The fifth wheel coupling according to claim 31, further comprising:
a secondary locking device movable between a locking position where the secondary locking device prevents a transfer from the coupling position to the disconnecting position in a form- or force-fitting manner, and a release position where the secondary locking device permits a transfer from the coupling position to the disconnecting position.

35. The fifth wheel coupling according to claim 31, wherein at least one of the primary coupling device and the secondary coupling device comprise a drive to translinearly move the primary coupling device and/or the secondary coupling device between the connected and disconnected position in the plug-in direction.
